(19) United States
(12) Patent Application Publication
(10) Pub. No.: US 2019/0366696 A1
(43) Pub. Date: Dec. 5, 2019

(54) MULTI-LAYER FILM

(71) Applicant: SABIC GLOBAL TECHNOLOGIES B.V., BERGEN OP ZOOM (NL)

(72) Inventors: Attilio Scala, Geleen (NL); Lucio Baccaro, Geleen (NL)

(21) Appl. No.: 16/481,081

(22) PCT Filed: Jan. 26, 2018
(86) PCT No.: PCT/EP2018/052014

§ 371 Date: Jul. 26, 2019

(30) Foreign Application Priority Data
Jan. 26, 2017 (EP) 17153240.1

(51) Int. Cl. B32B 27/08; B32B 27/32; C08L 23/06; C08L 23/08

(52) U.S. Cl. CPC B32B 27/08; C08L 2205/03; C08L 23/06; C08L 23/0815; B32B 2250/03; B32B 2250/242; B32B 2250/40; B32B 2307/5825; B32B 2307/734; B32B 2457/20; B32B 2571/00; C08L 2203/16; C08L 2207/066; C08L 2205/02; B32B 27/32

(57) ABSTRACT

The present invention concerns a multi-layer film comprising at least three layers, with two outer layers and one core layer, wherein the two outer layers comprise between >50 wt. % and 85 wt. % of a low density polyethylene having a density between 0.915 g/cm³ and 0.935 g/cm³ and between 15 wt.% and <50 wt. % of a polypropylene with a density between 0.890 and 0.920 g//cm³ based on the total weight of polymers of the layer, wherein further the core layer comprises an ethylene copolymer comprising 1-octene and having a density between 0.910 g/cm³ and 0.925 g/cm³.

The invention relates to a multi-layer film, especially for protection film applications, an article comprising said film and the use of said film.

Films for protection film applications may be used in packaging, especially to protect articles.

Films for protection film applications are thereby known for example from U.S. Pat. No. 8,685,523, which describes a film with a polypropylene substrate layer and an adhesive layer.

However, despite previous research in the field, there is always a continuous need for films with good optics and/or a good tear resistance and/or good rigidity and/or low stretching during the peeling off.

Protection films are typically used to provide temporary protection to a surface of an object such as during shipment and storage of an object before being made available to an end-user. The end-user typically needs to be able to remove the protection film from the object to access the surface of the object onto which the protection film has been applied. Commonly known examples of surfaces where such protection films are applied to during shipment and storage are display surfaces of electronic devices, such as smart phones and tablets, in particular touch-screen display surfaces. The protection film is applied to avoid any contamination, scratching, corrosion or other damage of the display surface to occur at any point between the manufacturing of the object and the initiation of the use by the end-user. The end-user needs to be able to easily remove the film from the protected surface without the film tearing, excessively stretching or leaving any remaining material of the surface. It is further desirable that the protection film is sufficiently transparent and clear to allow a view onto the protected surface even in the condition where the film is applied. It is further also desirable that the film itself has a certain resistance to scratching and puncturing as to ensure adequate protection of the underlying surface.

Therefore, it is the object of the invention to provide multi-layer films with good optics and/or a good tear resistance and/or good rigidity and/or low stretching during the peeling off. In particular, it is an object of the invention to provide multi-layer films that demonstrate a balance of these properties, i.e. good optics, tear resistance, rigidity and low stretching during peeling off.

This object is achieved by a multi-layer film comprising at least three layers, with two outer layers and one core layer, wherein the two outer layers comprise between >50 wt. % and 85 wt. % of a low density polyethylene having a density between 0.915 g/cm³ and 0.935 g/cm³ and between 15 wt. % and <50 wt. % of a polypropylene with a density between 0.890 and 0.920 g//cm³ based on the total weight of polymers of the layer, wherein further the core layer comprises an ethylene copolymer comprising 1-octene and having a density between 0.910 g/cm³ and 0.925 g/cm³.

With outer layers are meant the layers that are located on the outside of the film. The outer layers may thus preferably adjacent to only one other layer of the multi-layer film according to the invention on only one of their sides. As compared to other layers in the multi-layer film of the invention, the outer layers have a substantially larger portion of the layer that faces the outside. With core layer is meant a layer that is located between at least two outer layers, preferably in the middle of the multi-layer arrangement of the multi-layer film according to the invention, especially when the multi-layer film is film with at least three or exactly three layers.

With adjacent layer, as used herein, is meant a layer that is in direct contact with the layer to which it is described as adjacent, In direct contact may thereby mean that preferably no further layer is arranged between two layers which are in direct contact. Each adjacent layer to an outer layer, would therefore be in direct contact with that outer layers. A layer adjacent to at least one outer layer may thereby be for example a core layer.

The three layers of a multi-layer film according to the invention may preferably be adjacent to each other. This may mean that the core layer is in direct contact with both of the outer layers.

An ethylene copolymer may be a copolymer of ethylene and at least one α-olefin, preferably 1-octene.

In the context of the present invention, the ethylene copolymer that is comprised in the core layer may also be referred to as a linear low-density polyethylene or LLDPE.

In a multi-layer film according to the invention, the core layer may comprise for example between 55 wt. % and 100 wt. %, preferably between >60 wt. % and 100 wt. %, further preferred between >70 wt. % and 100 wt. %, further preferred between >80 wt. % and 100 wt. %, further preferred between >90 wt. % and 100 wt. %, further preferred between >95 wt. % and 100 wt. %, further preferred between >99 wt. % and 100 wt. % of the ethylene copolymer comprising 1-octene based on the total weight of polymers of the layer. This may further contribute to good optics and/or a good tear resistance and/or good rigidity and/or low stretching during the peeling off.

In a multi-layer film according to the invention, the outer layers may comprise for example between >60 wt. % and 80 wt. %, preferably between >65 wt. % and <80 wt. %, further preferred between 65 wt. % and 75 wt. %, of the low density polyethylene and between 20 wt. % and <40 wt. %, preferably between >20 wt. % and <35 wt. %, further preferred preferably between 25 wt. % and 35 wt. %, of the polypropylene based on the total weight of polymers of the layer. This may further contribute to good optics and/or a good tear resistance and/or good rigidity and/or low stretching during the peeling off.

In a multi-layer film according to the invention, the multi-layer film and/or each of the three layers according to the invention may comprise only polyolefins as polymers and/or the multi-layer film may preferably comprise no polybutene-1 and/or the multi-layer film may preferably comprise no polypropylene and/or the multi-layer film may preferably comprise no ethylene and vinyl acetate copolymer and/or no ethylene and vinyl alcohol copolymer and/or no copolymer of ethylene and an acrylate or methacrylate, especially for example acrylic acid or methacrylic acid, and/or the multi-layer film may preferably be a multi-layer film for protection film applications.

In a multi-layer film according to the invention, the density of the low density polyethylene of the outer layers may be between >0.915 and <0.932 g/cm³, preferably between >0.920 and <0.930 g/cm³ and/or the melt flow rate of the low density polyethylene of the outer layers may be between 0.2 and 3 g/10 min, preferably between 1 and 2.5 g/10 min.

In a multi-layer film according to the invention, the density of the polypropylene of the outer layers may be between >0.895 and <0.915 g/cm³, preferably between >0.900 and <0.910 g/cm³ and/or the melt flow rate of the polypropylene of the outer layers may be between 0.2 and 15 g/10 min, preferably between 5 and 12 g/10 min.

In a multi-layer film according to the invention, the density of the ethylene copolymer of core layer may be between 0.910 and 0.922 g/cm³, preferably between >0.910 and <0.920 g/cm³ and/or the melt flow rate of the ethylene copolymer of the core layer may be between 0.2 and 6 g/10 min, preferably between 0.5 and 4 g/10 min,

In a multi-layer film according to the invention, the melt flow rate of the low density polyethylene of the first outer layer and/or of the core layer may be lower than the melt flow rate of the low density polyethylene of the second outer layer.

For the purpose of the invention, the density may be determined using 1501873 (A) or ASTM-0 1505 or ASTM D792. For example, the density of the polypropylene may be determined in accordance with ASTM D792. For example, the density of the low density polyethylene may be determined in accordance with ASTM D1505. For example, the density of the ethylene copolymer comprising 1-octene may be determined in accordance with ASTM D1505.

For the purpose of the invention, the melt flow rate may be determined herein using ISO1133:2011 (190° C./2.16 kg) or ASTM D1238 (190° C./2.16 kg). In the context of the present invention, the melt flow rate is to be understood to be the melt mass flow rate. Preferably, the melt mass flow rate of polyethylene materials is determined in accordance with ISO 1133-1 (2011) at a temperature of 190° C. and a load of 2.16 kg. Preferably, the melt mass flow rate of polypropylene materials is determined in accordance with ISO 1133-1 (2011) at a temperature of 230° C. and a load of 5 kg.

In the multi-layer film of the invention, the core layer and/or the outer layers may for example comprise polyethylene, especially for example linear low density polyethylene and/or high density polyethylene and/or low density polyethylene and/or an ethylene copolymer and/or polypropylene and/or blends of two or more of thereof.

Besides polymers, each layer may also comprise other compounds. For example, each layer may especially further comprise additives as other compounds, especially for example additives as described herein.

A multi-layer film according to the invention may comprise at least one, preferably exactly one, core layer.

In a particular embodiment, the present invention relates to a multi-layer film comprising exactly three layers, wherein the film comprises two outer layers and one core layer, the core layer comprising a top surface and a bottom surface, wherein a first one of the outer layers is positioned onto the top surface of the core layer, and a second one of the outer layers is positioned onto the bottom surface of the core layer. Preferably, the outer layers are positioned onto the surfaces of the core layer in such way as to adhere to the core layer, thus forming a three-layer film wherein all three layers are adhering to each other.

It is preferred that the composition of the first one of the outer layers is the same as the composition of the second one of the outer layers.

In a preferred embodiment of the invention, the composition of the outer layers comprises between >50 wt % and 85 wt % of a low density polyethylene having a density between 0.915 g/cm³ and 0.30 g/cm³, as determined in accordance with ASTM D1505-10.

A multi-layer film according to the invention may comprise exactly five layers. A multi-layer film according to the invention may comprise exactly three layers.

The production processes of LOPE, HDPE and LLDPE are summarized in Handbook of Polyethylene by Andrew Peacock (2000; Dekker; ISBN 0824795466) at pages 43-66. The catalysts can be divided in three different subclasses including Ziegler Natta catalysts, Phillips catalysts and single site catalysts. The latter class is a family of different classes of compounds, metallocene catalysts being one of them. As elucidated at pages 53-54 of said Handbook a Ziegler-Natta catalyzed polymer is obtained via the interaction of an organometallic compound or hydride of a Group metal with a derivative of a Group IV-VIII transition metal. An example of a (modified) Ziegler-Natta catalyst is a catalyst based on titanium tetra chloride and the organometallic compound triethylaluminium. A difference between metallocene catalysts and Ziegler Natta catalysts is the distribution of active sites. Ziegler Natta catalysts are heterogeneous and have many active sites. Consequently, polymers produced with these different catalysts will be different regarding for example the molecular weight distribution and the comonomer distribution.

The low density polyethylene (LDPE) applied in the present film may be produced by a free radical polymerization process and/or without any catalyst and/or using an autoclave high pressure process or a tubular reactor process. Preferably, LOPE is produced by free-radical polymerisation in a tubular reactor process at high pressures, such as pressures of 150-350 MPa. LDPE is known to the skilled person to be different from linear low-density polyethylene (LLDPE), which commonly is produced in catalysed polymerisation reactions, for example at pressures of <10 MPa. Typical commercial production of LLDPE may be done using a Ziegler-Natta type catalyst, or using a single-site type catalyst, such as a metallocene-type catalyst. Each of these processes delivers very characteristic and unique polymers, which is well understood and recognised in the art. Examples of LLDPE and LOPE materials and their production processes are described in for example Polyethylene, Ullmann's Encyclopedia of Industrial Chemistry, DOI: 10.1002/14356007,a21_487.pub3.

An ethylene copolymer according to the present invention may thereby especially be linear low density polyethylene (LLDPE) and/or a polyolefin plastomer and/or a polyolefin elastomer.

With linear low density polyethylene (LLDPE) as used herein is meant a low density polyethylene copolymer ethylene-alpha olefin copolymer) comprising ethylene and a C3-C10 alpha-olefin co-monomer. Suitable alpha-olefin co-monomers include 1-butene, 1-hexene, 4-methyl-1-pentene and 1-octene.

Preferably, the alpha-olefin co monomer may be present for example in an amount of about 1 to about 25, preferably 5 to about 20 percent by weight of the ethylene-alpha olefin copolymer, preferably of 5 to about 20 percent by weight of the ethylene-alpha olefin copolymer, more preferably an amount of from about 7 to about 15 percent by weight of the ethylene-alpha olefin copolymer. LLDPE, as used herein, may be produced for example using metallocene and/or Ziegler-Natty catalysts. For example, the LLDPE may be produced using a metallocene catalyst.

The technologies suitable for the LLDPE manufacture include but are not limited to gas-phase fluidized-bed polymerization, polymerization in solution, and slurry polymerization.

According to a preferred embodiment of the present invention the LLDPE has been obtained by gas phase polymerization in the presence of a Ziegler-Natta catalyst. According to another preferred embodiment, the LLDPE may be obtained by gas phase or slurry polymerization in the presence of a metallocene catalyst. In another embodiment, the LLDPE may be obtained by a solution polymerisation process in the presence of a metallocene catalyst.

The components of each layer according to the invention may preferably for example add up to 100 wt. % of each layer or to 100 wt. % of the polymer content of each layer.

The thickness of multi-layer m of the invention may range for example from 5 to 600 pm, for example from 50 to 500 μm, especially for example between >75 to 400 μm. Not all layers in the multi-layer film of the invention need to have the same thickness. For example, one or more layers in the multi-layer film may be thicker than the other layers, especially for example to increase the stability of the production process.

In a multi-layer film according to the invention, the thickness of each outer layer may represent between 15% and 35% of the total film thickness, preferably between <20% and <30% of the total film thickness, further preferred 25% of the total film thickness and/or the thickness of the core layer may represent between 30% and 70% of the total film thickness, preferably between >40% and <60% of the total film thickness, further preferred 50% of the total film thickness.

Moreover, each layer of the multi-layer film of the invention may comprise an amount of additives of 0 to 25 wt. %, especially for example 1 to 10 wt. % especially for example 0 to 8 wt. % or 0.001 to 1 wt. % based on the total weight of the layer. The rest of each layer may thereby be made up of polymers.

Additives may thereby especially for example be UV stabilizers, antistatic agents, slip/anti-block agents, fillers, antioxidants, pigments, fluor elastomers used as polymer processing aids and/or mixtures of two or more thereof. Especially for example an erucamide and/or an oleamide and/or silica and/or talc.

A multi-layer film according to the invention may comprise at least three layers or exactly three layers, with two outer layers and one core layer, wherein the two outer layers comprise between >60 wt. % and 80 wt. % of a low density polyethylene having a density between >0.920 g/cm³ and <0.930 g/cm³ and between 20 wt.% and <40 wt. % of a polypropylene with a density between >0.895 and <0.915 g//cm³ based on the total weight of polymers of the layer, wherein further the core layer comprises 100 wt. % of an ethylene copolymer comprising 1-octene and having a density between >0.915 g/cm³ and 0.925 g/cm , wherein the multi-layer film and/or each of the three layers comprises only polyolefins as polymers and/or wherein further the three layers are adjacent to each other.

In a particular embodiment, the invention relates to a multi-layer film comprising at least three layers, preferably exactly three layers, with two outer layers and one core layer, wherein the two outer layers comprise between >50 wt. % and 85 wt. % of a low density polyethylene having a density between 0.915 g/cm³ and 0.935 g/cm³ and between 15 wt.% and <50 wt. % of a polypropylene with a density between 0.890 and 0.920 g/cm³ based on the total weight of polymers of the layer, wherein further the core layer comprises an ethylene copolymer comprising 1-octene and having a density between 0.910 g/cm³ and 0.925 g/cm³, wherein
the low density polyethylene is a low density polyethylene homopolymer having a density of between 0.915 and 0.930 g/cm³ , preferably of between 0.920 and 0.930 g/cm³ as determined in accordance with ASTM D1505, and a melt mass flow rate as determined in accordance with ISO 1133-1 (2011) at a temperature of 190° C. and a load of 2.16 kg of between 1 and 2.5 g/10 min, preferably between 1.0 and 2.5 g/10 min, more preferably between 1.5 and 2.0 g/10 min;
the polypropylene is a polypropylene copolymer having a density of between 0.890 and 0.920 g/cm³, preferably between 0.900 and 0.910 g/cm³, as determined in accordance with ASTM D792, and a melt mass flow rate as determined in accordance with ISO 1133-1 (2011) at a temperature of 230° C. and a load of 5 kg of between 0.2 and 10 g/15 min, preferably between 5.0 and 10.0 g/10 min; and
the ethylene copolymer comprising 1-octene is a linear low-density polyethylene having a density of between 0.910 and 0.925 g/cm³, more preferably between 0.915 and 0.920 g/cm³, as determined in accordance with ASTM 01505, and a melt mass-flow rate as determined in accordance with ISO 1133-1 (2011) at a temperature of 190° C. and a load of 2.16 kg of between 0.2 and 6 g/10 min, preferably between 1.0 and 4.0 g/10 min.

In a further particular embodiment, the invention relates to a multi-layer film comprising at least three layers, preferably exactly three layers, with two outer layers and one core layer, wherein the two outer layers comprise between >50 wt. % and 85 wt. % of a low density polyethylene having a density between 0.915 g/cm³ and 0.935 g/cm³ and between 15 wt.% and <50 wt. % of a polypropylene with a density between 0.890 and 0.920 g/cm³ based on the total weight of polymers of the layer, wherein further the core layer comprises an ethylene copolymer comprising 1-octene and having a density between 0.910 g/cm³ and 0.925 g/cm³, wherein
the low density polyethylene is a low density polyethylene homopolymer having a density of between 0.915 and 0.930 g/cm³ , preferably of between 0.920 and 0.930 g/cm³ as determined in accordance with ASTM D1505, and a melt mass flow rate as determined in accordance with ISO 1133-1 (2011) at a temperature of 190° C. and a load of 2.16 kg of between 1 and 2.5 g/10 min, preferably between 1.0 and 2.5 g/10 min, more preferably between 1.5 and 2.0 g/10 min;
the polypropylene is a polypropylene copolymer having a density of between 0.890 and 0.920 g/cm³, preferably between 0.900 and 0.910 g/cm³, as determined in accordance with ASTM D792, and a melt mass flow rate as determined in accordance with ISO 1133-1 (2011) at a temperature of 230° C. and a load of 5 kg of between 0.2 and 10 g/15 min, preferably between 5.0 and 10.0 g/10 min; and
the ethylene copolymer comprising 1-octene is a linear low-density polyethylene having a density of between 0.910 and 0.925 g/cm³, more preferably between 0.915 and 0.920 g/cm³, as determined in accordance with ASTM D1505, and a melt mass-flow rate as determined in accordance with ISO 1133-1 (2011) at a temperature of 190° C. and a load of 2.16 kg of between 0.2 and 6 g/10 min, preferably between 1.0 and 4.0 g/10 min
wherein the film has a thickness of 50 to 500 μm, preferably from 75 to 400 μm, an wherein preferably the thickness of the care layer is between 40 and 60% of the thickness of the total film.

The multi-layer films of the present invention may be prepared by any method known in the art. Multi-layer structures may be prepared for example by a blown film co-extrusion process, for example as disclosed in “Film Extrusion Manual”, (TAPPI PRESS, 2005, ISBN 1-59510-075-X, Editor Butler, pages 413-435).

For example, in the process of coextrusion, the various resins may be first melted in separate extruders and then brought together in a feed block. The feed block is a series of flow channels which bring the layers together into a uniform stream. From this feed block, this multi-layer material then flows through an adapter and out a film die. The blown film die may be an annular die. The die diameter may be a few centimeters to more than three meters across. The molten plastic is pulled upwards from the die by a pair of nip rolls high above the die (from for example 4 meters to more than 20 meters). Changing the speed of these nip rollers will change the gauge (wall thickness) of the film. Around the die an air-ring may be provided. The air exiting the air-ring cools the film as it travels upwards. In the center of the die there may be an air outlet from which compressed air can be forced into the center of the extruded circular profile, creating a bubble. This expands the extruded circular cross section by some ratio (a multiple of the die diameter). This ratio, called the “blow-up ratio” can be just a few percent to for example more than 300 percent of the original diameter. The nip rolls flatten the bubble into a double layer of film whose width (called the “layflat”) is equal to ½ of the circumference of the bubble. This film may then be spooled or printed on, cut into shapes, and heat sealed into bags or other items.

The present invention also concerns an article comprising a multi-layer film according to the invention.

The invention further relates in an embodiment to an article comprising a multi-layer film according to the invention wherein the multi-layer film is adhered to a surface in such way that the film can be removed from the surface without leaving remainders of the film material on the surface.

Such article may for example be a device comprising a pane, preferably a transparent pane, for example a glass pane, that is positioned such that at least one surface of the pane is arranged to face the outer side of the device, for example a display screen, wherein the multi-layer film is adhered to the pane so as to cover the surface of the pane that faces the outer side of the device. The pane may be flat, or alternatively the pane may be curved.

Such article may be for example a glass sheet, an electronic display, a television, a tablet computer, a laptop computer, a smartphone, or an automotive dashboard information screen.

Alternatively, such article may also be an automotive body panel

Furthermore, the present invention also concerns the use of the multi-layer film according to the invention for protection film applications, especially for protection films in high temperature adhesive coating processes, especially for example carried out using a temperature >75° C., preferable >90° C., further preferred ≥100° C.

In a certain embodiment, the invention relates to a process for applying the multi-layer film to a surface by the steps of:
a) providing the film;
b) providing an article comprising a surface to which the film is to be applied;
c) bringing the film to a temperature of >75° C., preferably >90° C., further preferably >100° C.;
d) bringing one of the surface of the heated film into contact with the surface to which the film is to be applied, preferably by applying a pressure onto the film to obtain a surface to which the film is contacted; and
e) cooling the film to a temperature of <50° C., to obtain an article comprising a surface to which the film is applied.

In particular, the invention relates to a process for applying the multi-layer film to a surface by the steps of:
a) providing the film;
b) providing an article comprising a surface to which the film is to be applied;
c) bringing the film to a temperature of >75° C., preferably >90° C., further preferably >100° C.;
d) bringing one of the surface of the heated film into contact with the surface to which the film is to be applied, preferably by applying a pressure onto the film to obtain a surface to which the film is contacted; and
e) cooling the film to a temperature of <50° C., to obtain an article comprising a surface to which the film is applied;

wherein the multi-layer film comprises at least three layers, preferably exactly three layers, with two outer layers and one core layer, wherein the two outer layers comprise between >50 wt. % and 85 wt. % of a low density polyethylene having a density between 0.915 g/cm³ and 0.935 g/cm³ and between 15 wt. % and <50 wt. % of a polypropylene with a density between 0.890 and 0.920 g/cm³ based on the total weight of polymers of the layer, wherein further the core layer comprises an ethylene copolymer comprising 1-octene and having a density between 0.910 g/cm³ and 0.925 g/cm³.

More preferably, the invention relates to a process for applying the multi-layer film a surface by the steps of:
a) providing the film;
b) providing an article comprising a surface to which the film is to be applied;
c) bringing the film to a temperature of >75° C., preferably >90° C., further preferably >100° C.;
d) bringing one of the surface of the heated film into contact with the surface to which the film is to be applied, preferably by applying a pressure onto the film to obtain a surface to which the film is contacted; and
e) cooling the film to a temperature of <50° C., to obtain an article comprising a surface to which the film is applied;
wherein the multi-layer film comprises exactly three layers, with two outer layers and one core layer, wherein the two outer layers comprise between >50 wt. % and 85 wt. % of a low density polyethylene having a density between 0.915 g/cm³ and 0.935 g/cm³ and between 15 wt. % and <50 wt. % of a polypropylene with a density between 0.890 and 0.920 g/cm³ based on the total weight of polymers of the layer, wherein further the core layer comprises an ethylene copolymer comprising 1-octene and having a density between 0.910 g/cm³ and 0.925 g/cm³.

It is further noted that the invention relates to all possible combinations of features described herein, preferred in particular are those combinations of features that are present in the claims.

It is further noted that the term ‘comprising’ does not exclude the presence of other elements. However, it is also to be understood that a description on a product comprising certain components also discloses a product consisting of these components. Similarly, it is also to be understood that a description on a process comprising certain steps also discloses a process consisting of these steps.

1. A multi-layer film comprising at least three layers, with two outer layers and one core layer, wherein the two outer layers comprise between >50 wt. % and 85 wt. % of a low density polyethylene having a density between 0.915 g/cm³ and 0.935 g/cm³ and between 15 wt.% and <50 wt. % of a polypropylene with a density between 0.890 and 0.920 g/cm³ based on the total weight of polymers of the layer, wherein further the core layer comprises an ethylene copolymer comprising 1-octene and having a density between 0.910 g/cm³ and 0.925 g/cm³.

2. The multi-layer film according to claim 1, wherein the outer layers comprise between >60 wt. % and 80 wt. %, preferably between >65 wt. % and <80 wt. %, further preferred between 65 wt. % and 75 wt. %, of the low density polyethylene and between 20 wt. % and <40 wt. %, preferably between >20 wt. % and <35 wt. %, further preferred preferably between 25 wt. % and 35 wt. %, of the polypropylene based on the total weight of polymers of the layer.

3. The multi-layer film according to claim 1, wherein the multi-layer film and/or each of the three layers comprise only polyolefins as polymers.

4. The multi-layer film according to any one of claim 1, wherein the density of the low density polyethylene of the outer layers is between >0.915 and <0.932 g/cm³, and/or the melt flow rate of the low density polyethylene of the outer layers is between 0.2 and 3 g/10 min.

5. The multi-layer film according to claim 1, wherein the density of the polypropylene of the outer layers is between >0.895 and <0.915 g/cm³, and/or the melt flow rate of the polypropylene of the outer layers is between 0.2 and 15 g/10 min.

6. The multi-layer film according to claim 1, wherein the density of the ethylene copolymer of core layer is between 0.910 and 0.922 g/cm³, and/or the melt flow rate of the ethylene copolymer of the core layer is between 0.2 and 6 g/10 min.

7. The multi-layer film according to claim 1, wherein the core layer comprises between 55 wt. % and 100 wt. %, of the ethylene copolymer comprising 1-octene based on the total weight of polymers of the layer.

8. The multi-layer film according to claim 1, the thickness of each outer layer represents between 15% and 35% of the total film thickness, and/or the thickness of the core layer represents between 30% and 70% of the total film thickness.

9. The multi-layer film according to claim 1, wherein the low density polyethylene (LDPE) is produced by a free radical polymerization process and/or without any catalyst and/or using an autoclave high pressure process or a tubular reactor process.

10. An article comprising a multi-layer film according to claim 1.

11. The article according to claim 10 wherein the multi-layer film is adhered to a surface in such way that the film can be removed from the surface without leaving remainders of the film material on the surface.

12. The article according to claim 10, wherein the article is a device comprising a pane, wherein the multi-layer film is adhered to the pane so as to cover the surface of the pane that faces the outer side of the device.

13. The article according to claim 10, wherein the article is a glass sheet, an electronic display, a television, a tablet computer, a laptop computer, a smartphone, an automotive dashboard information screen or an automotive body panel.

14. (canceled)

15. A process for applying a multi-layer film according claim 1 to a surface by the steps of:
a) providing the film;
b) providing an article comprising a surface to which the film is to be applied;
c) bringing the film to a temperature of >75° C.;
d) bringing one of the surface of the heated film into contact with the surface to which the film is to be applied; and
e) cooling the film to a temperature of <50° C., to obtain an article comprising a surface to which the film is applied.

16. The multi-layer film according to claim 1,
wherein the outer layers comprise between >65 wt. % and <80 wt. % of the low density polyethylene and between >20 wt. % and <35 wt. % of the polypropylene based on the total weight of polymers of the layer;
wherein the multi-layer film comprises no polybutene-1;
wherein the density of the low density polyethylene of the outer layers is between >0.920 and <0.930 g/cm³ and/or the melt flow rate of the low density polyethylene of the outer layers is between 1 and 2.5 g/10 min;
wherein the density of the ethylene copolymer of core layer is between >0.910 and <0.920 g/cm³ and/or the melt flow rate of the ethylene copolymer of the core layer is between 0.5 and 4 g/10 min;
wherein the core layer comprises between 80 wt. % and 100 wt. % of the ethylene copolymer comprising 1-octene based on the total weight of polymers of the layer; and
wherein the thickness of each outer layer represents between 15% and 35% of the total film thickness.

17. The multi-layer film according to claim 1, wherein the outer layers comprise between >65 wt. % and <80 wt. % of the low density polyethylene and between >20 wt. % and <35 wt. % of the polypropylene based on the total weight of polymers of the layer;
wherein the multi-layer film comprises no ethylene and vinyl acetate copolymer and/or no ethylene and vinyl alcohol copolymer and/or no copolymer of ethylene and an acrylate or methacrylate;
wherein the density of the low density polyethylene of the outer layers is between >0.920 and <0.930 g/cm³ and/or the melt flow rate of the low density polyethylene of the outer layers is between 1 and 2.5 g/10 min;
wherein the density of the ethylene copolymer of core layer is between >0.910 and <0.920 g/cm³ and/or the melt flow rate of the ethylene copolymer of the core layer is between 0.5 and 4 g/10 min;
wherein the core layer comprises between 80 wt. % and 100 wt. % of the ethylene copolymer comprising 1-octene based on the total weight of polymers of the layer; and
wherein the thickness of each outer layer represents between 15% and 35% of the total film thickness.
